(19) United States
(12) Patent Application Publication
(10) Pub. No.: US 2016/0216114 A1
(43) Pub. Date: Jul. 28, 2016

(54) LARGE-AREA ATOM INTERFEROMETRY WITH FREQUENCY-SWEPT RAMAN ADIABATIC PASSAGE

(71) Applicant: THE CHARLES STARK DRAPER LABORATORY, INC., Cambridge, MA (US)

(72) Inventors: Krish Kotru, Boston, MA (US); David L. Butts, Boston, MA (US); Joseph M. Kinast, Arlington, MA (US); Richard E. Stoner, Framingham, MA (US)

(21) Appl. No.: 15/006,705

(22) Filed: Jan. 26, 2016

Related U.S. Application Data
(60) Provisional application No. 62/219,350, filed on Sep. 16, 2015.
(60) Provisional application No. 62/107,823, filed on Jan. 26, 2015.

(51) Int. Cl. G01C 19/58; G21K 1/00

(52) U.S. Cl. CPC G01C 19/58; G21K 1/006

(57) ABSTRACT

A system and method for inertial sensing using large momentum transfer atom interferometry. Certain examples include applying a π/2-π-π/2 sequence to a cloud of atoms that produces 2k momentum splitting, and applying at least one augmentation pulse to the cloud of atoms to increase the momentum splitting. For instance, examples include atom optics that are based on stimulated Raman transitions and adiabatic rapid passage that produce momentum splittings of at least 30 photon recoil momenta in a Mach-Zhender interferometer. In some examples, substantial recapture of the atoms allows for higher data rates.

### CROSS REFERENCE TO RELATED APPLICATIONS

This application claims priority under 35 U.S.C. §119(e) to U.S. Provisional Application Ser. No. 62/107,823 titled “LARGE-AREA INTERFEROMETRY WITH FREQUENCY-SWEPT RAMAN ADIABATIC PASSAGE,” filed Jan. 26, 2015 which is incorporated herein by reference in its entirety.

This application is related to commonly owned, co-pending U.S. Provisional Application Ser. No. 62/219,350 titled “LARGE-AREA INTERFEROMETRY WITH FREQUENCY-SWEPT RAMAN ADIABATIC PASSAGE,” filed Sep. 16, 2015, which is incorporated herein by reference in its entirety.

### BACKGROUND

Atom interferometry provides a useful tool for precision measurements in geodesy, inertial navigation, and fundamental physics. In light-pulse atom interferometers, stimulated Raman transitions commonly provide the atom optics that coherently split, reflect, and recombine atom wavepackets. U.S. Pat. No. 5,274,231 and U.S. Pat. No. 5,274,232, each of which is herein incorporated by reference in its entirety, disclose examples of methods and apparatus for manipulating quantum objects, such as atoms, using stimulated Raman transitions. The conventional Raman beamsplitter implementation, which uses resonant pulses to drive atomic transitions, is sensitive to variations in the intensity and difference frequency of the Raman optical fields. These variations can be minimized in a laboratory setting, but will be unavoidably larger in dynamic environments, degrading the performance of practical sensors. In addition, Raman pulses are limited in the thermal velocity range of atoms that can be effectively addressed.

Adiabatic rapid passage (ARP; also known as adiabatic fast passage (AFP)) is a technique used in nuclear magnetic resonance (NMR) to produce rotation of the macroscopic magnetization vector by shifting the frequency of radio frequency (RF) energy pulses (or the strength of the magnetic field) through resonance (the Larmor frequency) in a time that is short compared to the relaxation times. Rather than applying an RF tipping field of fixed orientation and magnitude orthogonal to the holding magnetic field, a field of variable direction is initially applied parallel to an initial polarization and swept into the desired orientation. The polarization is “dragged” while preserving its relative orientation angle with the RF field if the sweep occurs on a timescale much longer than a period of precession about the RF field. One method of varying the RF tipping field direction is by sweeping the RF frequency, as discussed, for example, in U.S. Pat. No. 4,695,799. U.S. Pat. No. 4,695,799 discloses various frequency sweep regimens in the context of NMR.

An optical beamsplitter method using adiabatic rapid passage is discussed in Atomic interferometer based on adiabatic population transfer, Weitz et al., Phys. Rev. Lett. Vol. 73, pp 2563-2566 (1994), and in Precision atom interferometry with light pulses, B. Young et al., in Atom Interferometry, ed. P. Berman (Academic Press, 1996), p. 363. In this method, a pair of laser beams with a fixed laser frequency difference, but having variable laser beam power, was used to achieve atomic population transfer.

### SUMMARY

Aspects and embodiments are directed to methods and an apparatus that allow for inertial sensing using large momentum transfer atom interferometry. In accordance with one or more embodiments, a method of inertial sensing using large momentum transfer atom interferometry comprises trapping and cooling a cloud of atoms that includes a plurality of atom wave packets, applying a first π/2 beam splitter pulse sequence to the cloud of atoms to drive a first Raman transition and divide the atom wave packets, applying a π mirror sequence to the cloud of atoms to drive a second Raman transition and recombine the atom wave packets, applying a second π/2 beam splitter pulse sequence to the cloud of atoms to drive a third Raman transition and overlap atom wave packets to produce interference among the plurality of atom wave packets, a combination of the first π/2 beam splitter pulse sequence, the π mirror sequence, and the second π/2 beam splitter pulse sequence producing a 2k momentum splitting between interfering atom wave packets of the plurality of atom wave packets, applying at least one augmentation pulse to the cloud of atoms to increase the momentum splitting to a value greater than 2k, the at least one augmentation pulse being at least one of a Raman pulse, a composite pulse, and an adiabatic rapid passage (ARP) pulse, performing at least one inertial sensing measurement on the cloud of atoms during an interrogation time, and generating a control signal based on the at least one inertial sensing measurement.

According to one embodiment, the first and second π/2 beam splitter pulse sequences, the π mirror sequence, and the at least one augmentation pulse are applied in a Mach-Zehnder atom interferometer. According to another embodiment, applying the at least one augmentation pulse increases the momentum splitting to a value of at least 4k. According to a further embodiment, the momentum splitting is increased to a value of at least 30k.

According to certain embodiments, the at least one augmentation pulse is an ARP pulse. According to another embodiment, the ARP pulse is a tan/tan h pulse. According to another embodiment, the ARP pulse has a duration of 10t_{π}.

According to some embodiments, performing the at least one inertial sensing measurement is determined at a specified periodic rate of at least 100 Hz. According to at least one embodiment, the π mirror sequence is applied following the first π/2 beam splitter pulse sequence after a dwell time of at least 5 ms. According to some embodiments, the at least one augmentation pulse is chirped at a predetermined rate. According to one embodiment, the predetermined rate is ±23 kHz/ms.

In accordance with some embodiments, the method further comprises recapturing a substantial portion of the atom wave packets of the cloud of atoms following performance of the at least one inertial sensing measurement. According to some embodiments, the at least one augmentation pulse includes a plurality of augmentation pulses temporally separated from one another by a predetermined time τ. According to another embodiment, the method further comprises modulating a phase of at least one of the first and second π/2 beam splitter pulse sequences.

In accordance with one or more embodiments, an atom interferometer is provided. According to at least one embodiment, the atom interferometer comprises an atom cloud including a plurality of atom wave packets, a trap configured to trap and cool the plurality of atom wave packets to a predetermined temperature and launch the plurality of atom wave packets into an interferometry region, at least one laser light source disposed adjacent to the interferometry region and configured to generate and direct a sequence of light pulses into the interferometry region, and a controller coupled to the at least one laser light source and configured to obtain at least one inertial sensing measurement from the atom cloud and control the at least one laser light source to: apply a first π/2 beam splitter pulse to drive a first Raman transition and divide the atom wave packets, apply a π mirror sequence to drive a second Raman transition and recombine the atom wave packets, apply a second π/2 beam splitter pulse to drive a third Raman transition and overlap the atom wave packets to produce interference among the plurality of atom wave packets, a combination of the first π/2 beam splitter, the π mirror sequence, and the second π/2 beam splitter pulse producing a 2k momentum splitting between interfering atom wave packets of the plurality of atom wave packets, and apply at least one augmentation pulse, the at least one augmentation pulse being at least one of a Raman pulse, a composite pulse, and an adiabatic rapid passage (ARP) pulse and configured to increase the momentum splitting to a value greater than 2k.

According to some embodiments, the trap is a first trap and the atom interferometer further comprises a second trap, the second trap configured to capture a substantial portion of the plurality of atom wave packets launched into the interferometry region by the first trap. According to another embodiment, the at least one augmentation pulse is configured to increase the momentum splitting to a value of at least 30k. According to some embodiments, the at least one laser light source comprises counter-propagating beams of light directed at the plurality of atom wave packets. According to another embodiment, the atom interferometer further comprises an electro-optic modulator coupled to the at least one laser light source and is configured to modulate a phase of at least one of the first and second π/2 beam splitter pulse sequences. According to some embodiments, the π mirror sequence is applied after a first dwell time after the first π/2 beam splitter pulse, and the second π/2 beam splitter pulse is applied after a second dwell time after the π mirror sequence, the first and the second dwell time having a duration of at least 5 msec.

Still other aspects, embodiments, and advantages of these example aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Embodiments disclosed herein may be combined with other embodiments, and references to “an embodiment,” “an example,” “some embodiments,” “some examples,” “an alternate embodiment,” “various embodiments,” “one embodiment,” “at least one embodiment,” “this and other embodiments,” “certain embodiments,” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a diagram of pulse timings and wave-packet trajectories for Mach-Zehnder interferometers having three different beam splitter pulses according to aspects of the invention;

FIG. 2 is a diagram schematically illustrating the intermediate excited states for a stimulated Raman process according to aspects of the invention;

FIG. 3 is a diagram schematically illustrating a Bloch sphere depiction of frequency-swept adiabatic rapid passage, with poles corresponding to alkali-metal clock states according to aspects of the invention;

FIGS. 4A-4D are a series of diagrams schematically illustrating a Raman ARP Ramsey sequence on a Bloch sphere according to aspects of the invention;

FIG. 5 is a diagram schematically illustrating movement of a polarization on the Bloch sphere caused by rotating the effective drive field according to aspects of the invention;

FIG. 6 is a diagram further schematically illustrating that rotation of the effective drive field produces efficient coherent transfer of atomic population from one ground state to another, according to aspects of the invention;

FIG. 7 is a diagram schematically illustrating a combiner frequency sweep in which rotation of the effective drive field causes polarization movement on the Bloch sphere according to aspects of the invention;

FIG. 8A is a diagram schematically illustrating an RCAP beamsplitter frequency sweep applied to an atomic coherence, according to aspects of the invention;

FIG. 8B is a diagram schematically illustrating a phase reversal combiner frequency sweep applied to the polarization produced by the beamsplitter sweep of FIG. 7A, according to aspects of the invention;

FIG. 9 is diagram schematically illustrating an octagonal glass vacuum chamber and laser beam configuration for atom trapping, state preparation, and interferometry according to aspects of the invention;

FIG. 10 is a series of graphs illustrating phase shift per unit acceleration Δφ/a for various LMT orders according to aspects of the invention;

FIG. 11A is a histogram of transition probabilities from an interferometer according to aspects of the invention;

FIG. 11B is a graph illustrating an example of contrast as a function of LMT order according to aspects of the invention;

FIG. 11C is a graph illustrating an example of a spatial intensity profile of the central portion of one Raman beam according to aspects of the invention;

FIG. 12A is a graph illustrating contrast response as a function of dwell time according to aspects of the invention;

FIG. 12B is a graph illustrating contrast as a function of ARP duration;

FIG. 12C is a graph illustrating contrast as a function of ARP sweep rate according to aspects of the intention;

FIG. 12D is a graph illustrating contrast as a function of maximum detuning; and

FIG. 13 is a flow diagram of one example of a method according to aspects of the invention.

### DETAILED DESCRIPTION

Atom interferometry may be used in a variety of applications, including precision metrology applications such as inertial sensors, accelerometers, and gyroscopes. For example, light-pulse atom interferometry (LPAI) is a method that may be used for precision measurements of inertial forces and fundamental physical constants. Highly sensitive LPAI systems may be an enabling technology for next-generation inertial navigators, gravitational wave detectors, and tests of the equivalence principle. Nevertheless, many light-pulse atom interferometers are presently limited by atom beam splitters and mirrors that create small momentum separations (two photon recoil momenta) between diffracting wave packets. The sensitivity of these interferometers typically increases with the effective area enclosed by the interfering wave packets. Since this area is proportional to momentum separation, sensitivity can be enhanced using atom optics that generate large momentum transfer (LMT).

Previous techniques using atom interferometry with LMT atom optics have taken several different approaches, including sequential application of stimulated Raman transitions, Raman composite pulses, and stimulated Raman adiabatic rapid passage (STIRAP) pulses, as well as application of multiphoton-Bragg transitions, and Bloch oscillations in an optical lattice. In most of these demonstrations, cold atoms from a magneto-optical trap (MOT) were either evaporatively cooled or velocity selected. Both of these techniques typically discard >90% of the original atom sample. A reduced atom number is detrimental to atom shot-noise-limited measurement uncertainty and to operation at fast data rates. A slower data rate results because following every measurement cycle, the steady-state atom number in the MOT must be recovered primarily from atoms that are at room temperature. When cold atoms are recaptured, however, fewer atoms must be loaded from the room temperature background vapor, thus allowing the data rate to be increased above 100 Hz. High data rates are crucial for atom interferometric measurements of dynamic signals, such as rapidly varying accelerations and rotations of moving platforms, as well as strains from high frequency (˜10 Hz) gravitational waves. The fastest data rates with evaporative cooling have been limited to ≦1.3 Hz; velocity selection at high data rates requires the added complexity of a 2D MOT to maintain atom number.

According to various aspects of the invention, cold atom interferometers are provided with at least 30k beam splitter pulses without evaporative cooling and velocity selection. In accordance with at least one embodiment, the atom beam splitters are implemented in an acceleration-sensitive interferometer and use a combination of stimulated Raman transitions and frequency-swept adiabatic rapid passage (ARP). The systems and methods disclosed herein include atom optics that enable large-area atom interferometry with improved counting statistics, fast data rates, and reduced constraints on the atom temperature. These features are useful for measurement of dynamic signals, such as accelerations and rotations of a moving platform. According to certain aspects, the approach to ARP disclosed herein is different from typical demonstration of STIRAP, as discussed further below.

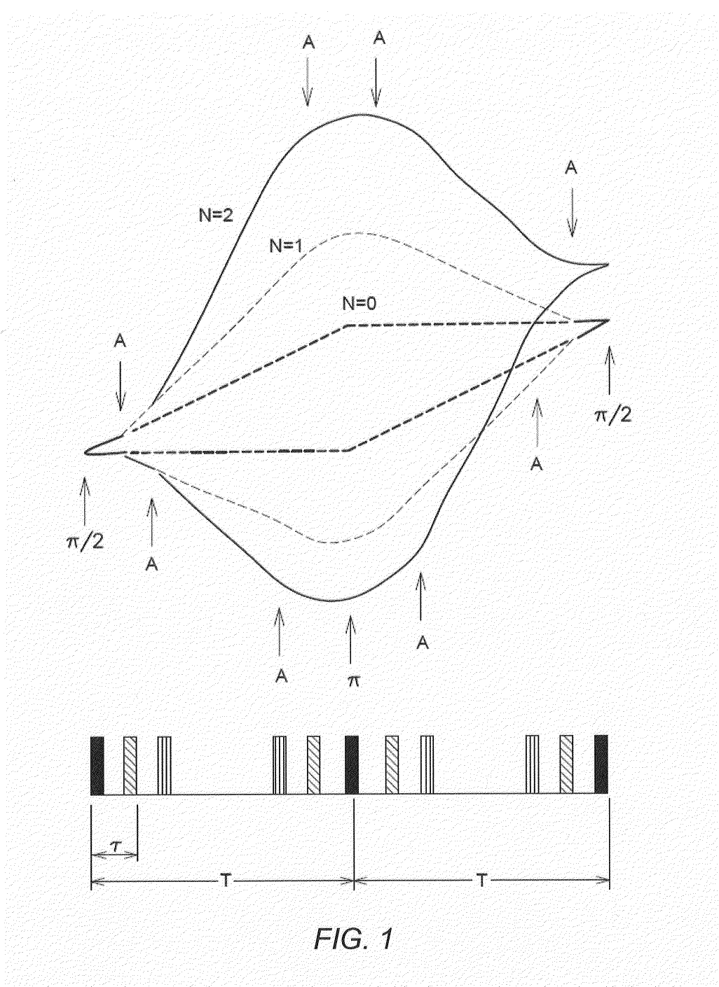

In accordance at least one embodiment. LMT atom optics are applied in a Mach-Zehnder atom interferometer, which is shown in FIG. 1, and illustrates a space-time diagram that presents examples of use of augmentation events to increase interferometer sensitivity. The interferometer is composed of a beam splitter pulse sequence that divides the atom wave packet, a mirror sequence that brings the wave packets back together, and a second beam splitter sequence that overlaps the wave packets to create interference. According to some embodiments, the second beam splitter functions as a “detector” for the purposes of obtaining measurements, and the interferometer may be equipped with one or more output ports or other mechanism or device for providing and/or performing one or more measurements. The first (π/2), middle (π), and final (π/2) pulses drive Raman transitions that produce the nominal interferometer with 2k momentum splitting between diffracting wave packets. Achieving higher momentum splittings requires “augmentation” pulses (“A”) with wave vectors orientated according to the vertical arrows in FIG. 1. Thus, the two large area interferometers (N=1, 2) are shown with a conventional π/2-π-π/2 (N=0) interferometer, and the augmentation pulses are denoted by an “A” and are at least one of Raman pulses, composite pulses, or ARP sweeps. Composite pulses are concatenated sequences of light pulses, two non-limiting examples of which includes π/2_{0°}-π_{90°}-π/2_{0°}, and π/2_{0°}-π_{180°}-3π/2_{0°}, where the primary values correspond to subpulse area and the subscripts represent the relative Raman laser phase difference between subpulses. The mirror sequence comprises N augmentation pulses before and after the mirror a pulse in order to achieve loop closure. For example, additional momentum is transferred by inserting at least one of Raman pulses, so-called “composite pulses,” and ARP pulses with alternating propagation directions \vec{k}_{eff}. Applying at least one augmentation pulse may therefore increase the momentum splitting between interfering atom wave packets to a value greater than 2k. For instance, according to some embodiments, the augmentation pulse(s) may increase the momentum splitting to a value in a range of at least 2k to a value of at least 100k, for example, at least 2k, at least 4k, at least 6k, at least 10k, at least 14k, at least 20k, at least 30k, at least 50k, and at least 100k. In the absence of gravity gradients, the augmentation pulse sequence produces a relative phase between the interferometer arms may be expressed below by Equation (1):

$$Δ φ = {k}_{eff} \cdot a [ ( 2 N + 1 ) {T}^{2} - 2 N ( N + 1 ) T τ ] \qquad Equation ( 1 )$$

where
a is an acceleration,
k_{eff} is the effective Raman wave vector,
T is the dwell time, and
augmentation pulses in the beam splitter are numbered 1 to N and separated by time τ.
As explained further below, the augmentation pulses (A) are either Raman π, composite pulses, or ARP pulses.

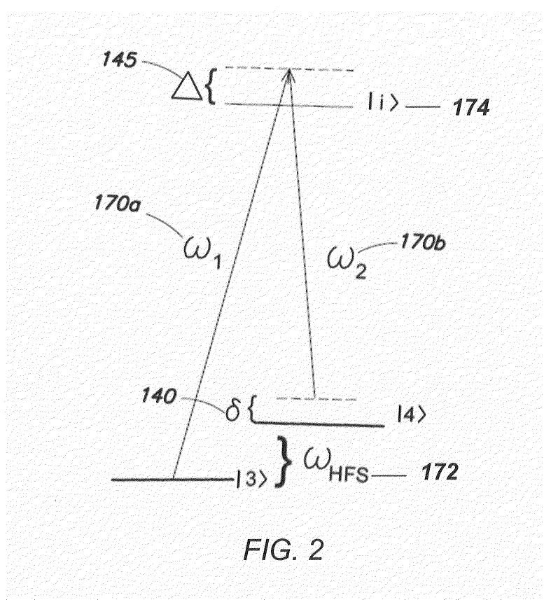

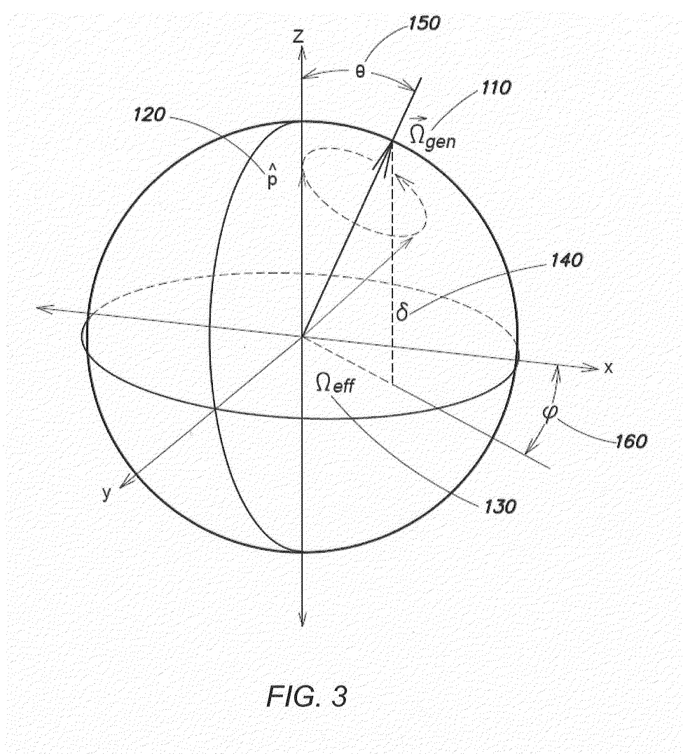

As shown in the energy-level diagram in FIG. 2, each atom optics pulse generates a two-photon Raman transition between alkali-metal (e.g., cesium 133) hyperfine ground states |3 [symbol] and |4 [symbol] , separated by energy ω_{HFS} (172). The transition is produced by counterpropagating optical frequencies ω₁ and ω₂ (170a and 170b), with two-photon detuning δ (140) and one-photon detuning Δ (145), defined with respect to an excited state |i [symbol] (174). To improve the atomic coherence during LMT, augmentation pulses may be used that are based on frequency-swept ARP with Raman transitions. In direct analogy to ARP methods from nuclear magnetic resonance, Raman ARP in an effective two-level system inverts the population with high fidelity by slowly sweeping the Raman detuning δ through resonance. As seen on the Bloch sphere in FIG. 3, the Bloch vector \hat{p} 120 adiabatically follows the Raman drive field \vec{Ω}_{gen} 110 when θ 150<<Ω_{gen}. Here, Ω_{gen}=\sqrt{Ω_{eff}²+δ²} determines the rate of precession of \hat{p} 120 about \vec{Ω}_{gen} 110, and Ω_{eff} 130 is the magnitude of the two-photon Rabi rate. Control of θ 150 may be achieved by varying δ 140 and Ω_{eff} 130.

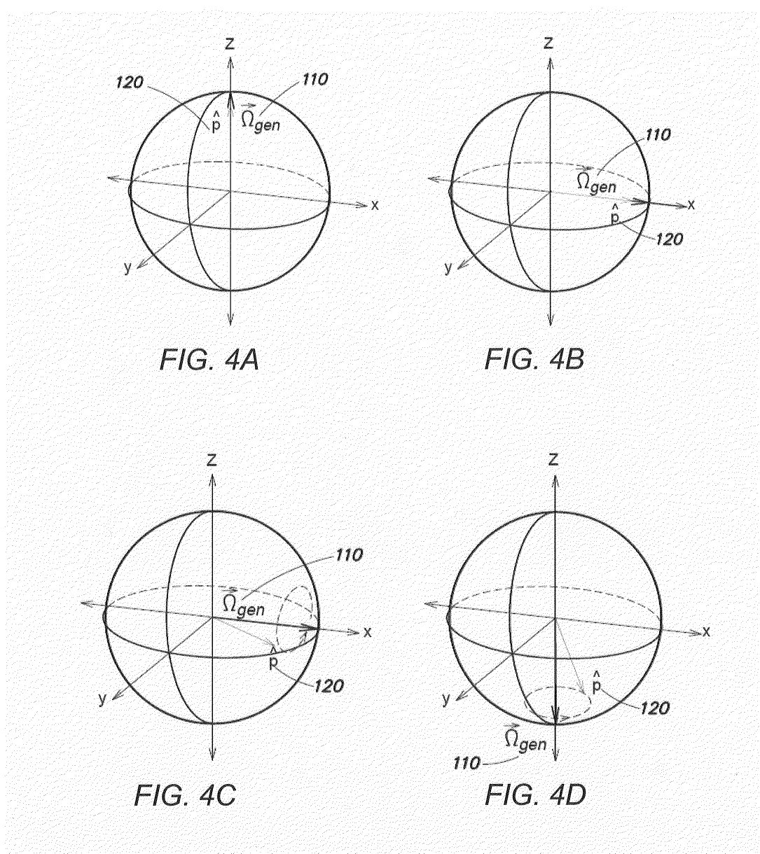

For example, in FIG. 4A, a first Ramsey pulse may begin with \vec{Ω}_{eff} 110 and \hat{p} 120 initially parallel after state preparation. The drive field 110 then slowly drags the pseudospin 120 into the x-y plane, as shown in FIG. 4B, creating a coherent superposition of the clock states. Thus, the first sweep transfers the pseudospin polarization into the x-y plane when its center frequency matches the Raman resonance condition. After an interrogation time T, a second beamsplitter starts nearly on resonance to complete the Ramsey sequence. At the beginning of this pulse, \vec{Ω}_{gen} 110 and \hat{p} 120 are generally nonparallel, because of discrepancies between the oscillator and atomic resonance frequencies—which the atomic reference is intended to correct. The misalignment leads to the precession of \hat{p} 120 about \vec{Ω}_{gen} 110, as shown in FIG. 4C. The drive field 110 (second beamsplitter) then drags \vec{p}∥ to the z axis, as shown in FIG. 4D, thereby converting the interferometer phase, i.e., the relative phase between the drive field and pseudospin polarization, into population difference.

Interferometry with adiabatic transfer based on STIRAP fundamentally differs from the frequency-swept ARP approach used in the methods and systems disclosed here since STIRAP relies solely on optical intensity modulation with δ=0 and Δ≈0. In fact, STIRAP may be ill-suited to the systems and methods disclosed herein, since the techniques used for STIRAP would cause half the atoms to spontaneously emit during each augmentation pulse and significantly decrease sensitivity.

In the adiabatic limit, frequency-swept ARP imprints a dynamic phase that may be expressed below by Equation (2):

γ=±∫dtΩ_{gen}(t)/2 Equation (2):

The dynamic phase may be imprinted onto the atom wave packet with a sign that depends on the internal state label. Since augmentation pulses act simultaneously on both internal states (one in each interferometer arm), every ARP adds a phase with magnitude |2γ| to the interferometer output. The dependence of γ on optical intensity can create decoherence when the spatial intensity pattern varies across the atom sample. According to various embodiments, the interferometers disclosed herein are configured to maintain coherence because pairs of identical ARPs nearly cancel the dynamic phase imprinted on a particular wave packet. This cancellation, or “rephasing,” is efficient when beam splitter augmentation pulses occur in rapid succession. A cold atom in this case traverses just a few microns between pulses and thus avoids large-scale spatial intensity variation. A quantitative evaluation of dynamic phase is provided further below as part of the discussion of experimental interferometry results.

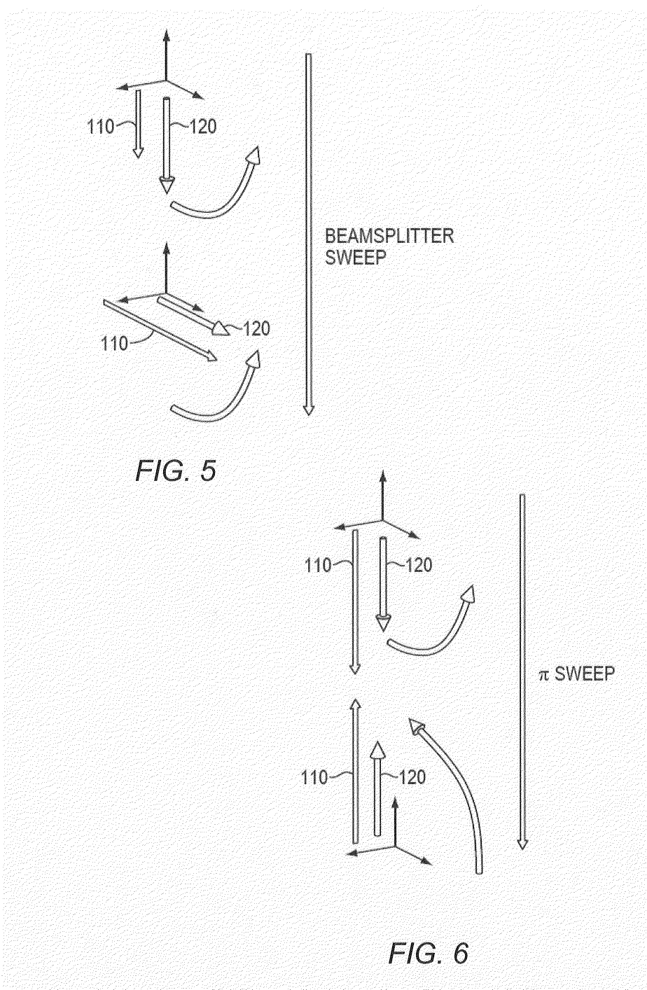

Referring to FIGS. 5-8B, various types of sweeps may be used in atom interferometers, and may be useful in ARP. For instance, beamsplitter, inversion, combiner, and mirror sweeps, as discussed further below, may be combined together or with standard Raman pulses to implement a variety of different configurations depending on the application. Furthermore, the intensity of the Raman lasers may be systematically varied during the sweeps described below to improve efficiency.

Referring to FIG. 5, and applying an NMR analogy to the atom, at the start of a frequency sweep, the effective drive field 110 is aligned with the initial polarization 120 of the atomic system, which is analogous to FIG. 4A discussed above. As the effective drive field 110 rotates (changes orientation on the Bloch sphere as a result of the time-varying frequency difference), the polarization 120 follows the effective drive field, and as also shown in FIG. 4B. The drive field may be turned off in the equatorial plane, resulting in an atomic beamsplitter.

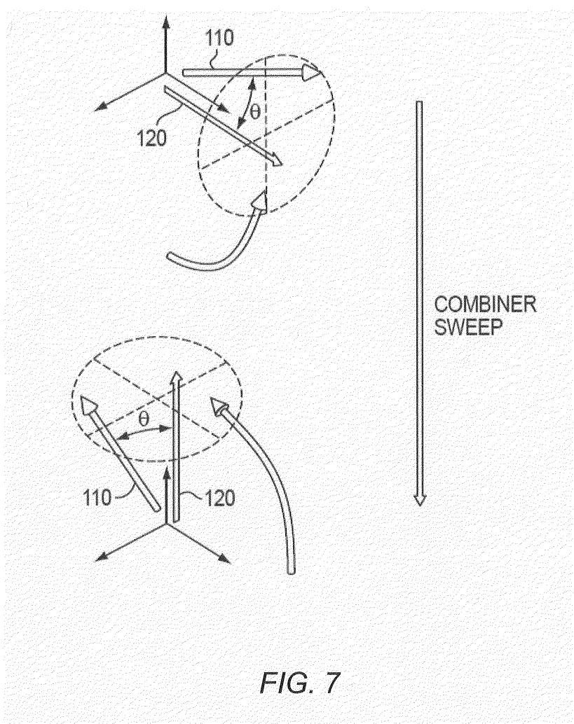

FIG. 6 illustrates how the sweep of FIG. 5 can be continued to the opposite pole, thus comprising an inversion sweep that produces efficient coherent transfer of atomic population from one ground state to another.

FIG. 7 illustrates a combiner sweep, which is analogous to the inverse of the beamsplitter shown in FIG. 5 and FIG. 4B. In a combiner sweep, the effective drive field 110 is initially on the equatorial plane of the Bloch sphere, at an angle θ with a polarization 120 that is also oriented in the equatorial plane. As the effective drive field 110 rotates, the polarization 120 precesses about the drive field, but their relative angle of orientation θ is preserved. When the drive field 110 rotates to polar orientation, the polarization 120 is oriented at an angle θ with respect to the pole. Measuring the atom's relative ground state population thus reveals the relative phase of the initial polarization with respect to the initial effective drive field.

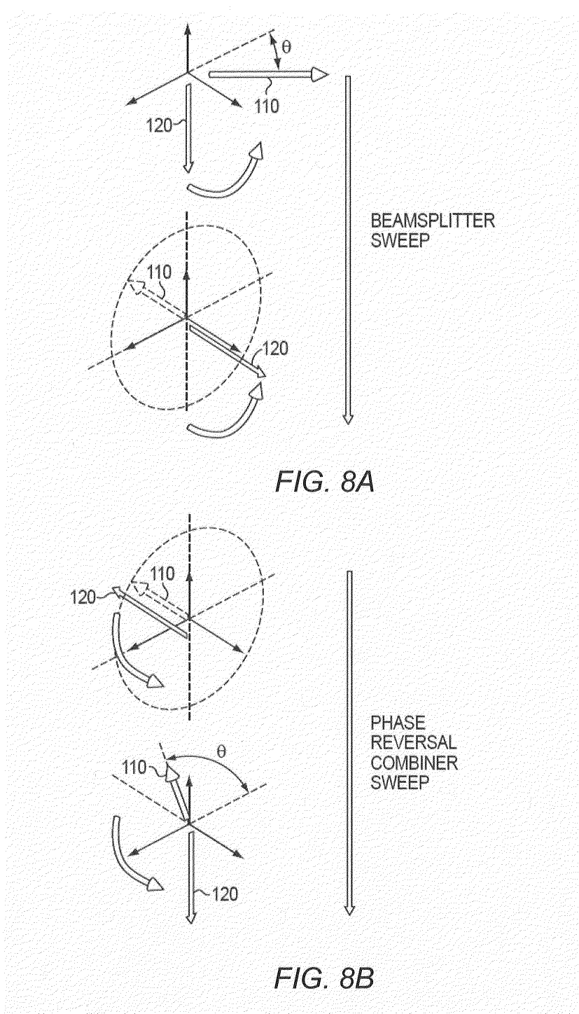

FIGS. 8A and 8B illustrate a sequence of two concatenated sweeps which taken together will be referred to as a mirror sweep. A mirror sweep is analogous to a paired combination of the beamsplitter and combiner, or inverse of the beamsplitter, discussed above. FIG. 8A illustrates application of an effective drive field 110 initially in a polar orientation, to a polarization 120 oriented in the equatorial plane at an angle θ with respect to the axis of rotation of the drive field. The drive field rotates into the equatorial plane. The polarization precesses about the drive field at a rate proportional to the drive field strength, and ends up in the plane normal to the drive field and containing the drive field rotation axis (i.e., the beamsplitter sweep). The orientation of the polarization 120 in that plane is determined by the effective drive field strength and the duration of the sweep. The phase of the drive field 110 is then incremented by π, as depicted in FIG. 8B, and swept back to its original polar orientation. The field strength and sweep duration are substantially the same as those used in the first sweep. The polarization thus precesses through the same angle about the drive field 110 as during the first sweep, but in the opposite sense, so that its final orientation is in the equatorial plane at the angle θ with respect to the axis of orientation as shown (i.e., the phase reversal combiner sweep). Thus, the polarization 120 has been “mirrored” in the equatorial plane with respect to the polarization axis of rotation.

### Examples

The function and advantages of these and other embodiments will be more fully understood from the following examples. These examples are intended to be illustrative in nature and are not to be considered as limiting the scope of the systems and methods discussed herein. The following examples demonstrate atom interferometry with Raman chirped adiabatic passage sweeps using the apparatus described below.

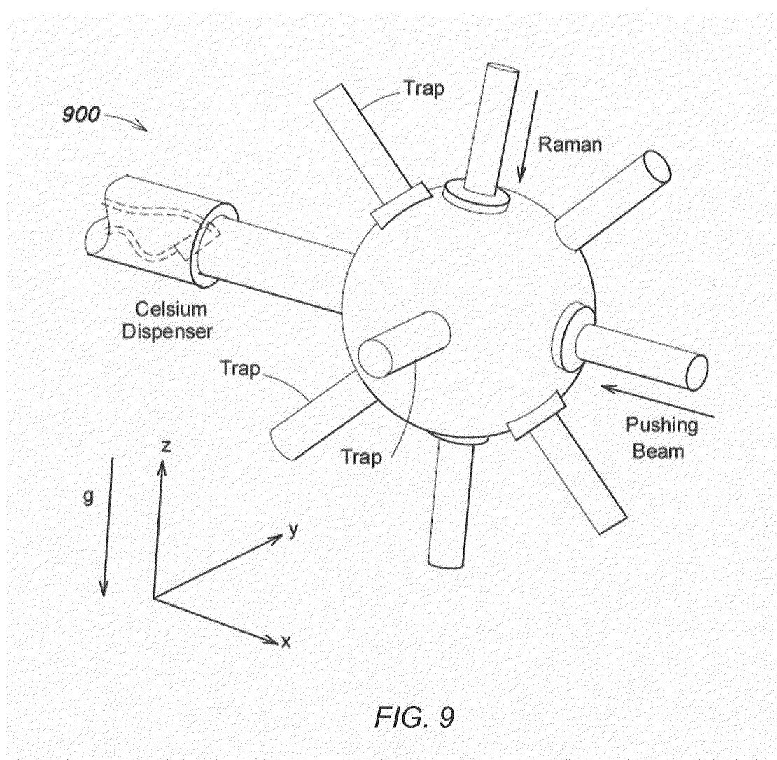

In particular, the interferometry experiments were conducted using D2 line cesium 133 atoms and were conducted inside an octagonal 80-cm³ machined-quartz cell, having a diameter of 2.75 inches, such as the one shown at 900 in FIG. 9, which maintained a background vapor pressure of approximately 10⁻⁹ Torr. During experiments, atoms fall through the center of the Raman beam because of its vertical orientation. Environmental magnetic fields were canceled by three orthogonal pairs of Helmholtz coils. Each measurement cycle began with the cooling and trapping of ˜10⁶ atoms using a magneto-optical trap (MOT). Polarization gradient cooling further cooled the cloud to 9 μK. Prior to interferometry, about 90% of the atoms were optically pumped to the |6²S_{1/2}, F=4, m_{F}=0 [symbol] upper clock state and then transferred to the |6²S_{1/2}, F=3, m_{F}=0 [symbol] lower clock state with a microwave π pulse. A pusher beam removed the remaining 10% of atoms from the interaction region. Following the interferometer pulse sequence, the atom population in each clock state was measured by sampling the laser induced fluorescence f₃, f₄ from each hyperfine ground state with a photodiode. The interferometer phase was then extracted from the normalized F=4 population, f₄/(f₃+f₄).

As previously mentioned, the methods and systems disclosed herein may include recapturing a substantial portion of the atoms following an interferometric measurement sequence. The recaptured atoms are at or kept at cold temperatures and may be therefore be used in subsequent measurements. This decreases the inefficiencies associated with loading atoms at room temperature and then cooling them after the first measurement sequence. According to some embodiments, the cold atoms are recaptured by returning them to the trapping region, and in some instances the cold atoms remain near the trapping region for subsequent recapture. According to some embodiments, the atom interferometer may include one or more trapping regions, such as MOTs. Thus, a first measurement sequence may use atoms launched from a first trapping region into the interferometric region, and after completion of the first measurement sequence, the atoms may be trapped by a second trapping region and launched into the interferometric region to perform a second measurement sequence. According to other embodiments, the atom interferometer may be configured to recapture the cold atoms without the need of a second trapping region. A controller may also be used to control the measurement sequence so as to enable recapture of a substantial portion of the cold atoms.

Two injection-locked Fabry-Perot slave lasers produced Raman frequencies ω₁ and ω₂. Both lasers were seeded by a master external cavity diode laser, whose output was phase modulated by an electro-optic modulator (EOM) driven at ˜9 GHz. The EOM produced optical frequency sidebands spaced about the carrier by integer multiples of the driving frequency. Each slave laser received roughly 100 μW of optical power from the phase-modulated master and was tuned to predominantly amplify either the carrier or the negative first-order frequency sideband. In addition, the master laser was red detuned from the |6²S_{1/2}, F=3, m_{F}=0 [symbol] →|6²P_{3/2}, F=4 [symbol] transition by −3.9 GHz to reduce the spontaneous emission rate to R_{sd}=0.004 per Raman π pulse. The two Raman frequencies were delivered to the vacuum cell with separate polarization-maintaining optical fibers. The fiber outputs were collimated to 1=e² intensity diameters of 7.1 mm, were crossed-linearly polarized with 1″ polarization beamsplitting cubes, and counterpropagated along a common axis that was aligned to within ±0.5° of vertical.

Agile control of the Raman detuning was achieved through the rf signal delivered to the EOM. The rf was produced by mixing the 30-MHz output of a 625 megasamples/s (MS/s) arbitrary waveform generator with a constant ˜9-GHz signal using a single-sideband mixer. During an interferometer sequence, the Raman frequency difference was chirped at ±23 kHz/ms to continually match the Doppler-shifted Raman resonance in a 1-g environment. The upward or downward orientation of k_{eff} determined the sign of the chirp rate. A combination of two AOMs and polarization-selective optics enabled rapid optical switching (˜50 ns) and reversal of k_{eff}. The optical power in each Raman beam was increased to ˜100 mW with tapered amplifier (TA) diodes. The resulting two-photon Rabi rate was Ω_{eff}=2π×200 kHz, corresponding to a Raman π pulse duration of tπ=2.5 μs. The tapered amplifier drive currents were also tuned to obtain a ratio of optical powers that canceled the differential AC Stark shift of the clock states.

To reduce spontaneous emission during LMT, a relatively short tan/tan h ARP pulse was used. The time-dependent ARP detuning may be expressed below by Equation 3:

δ(t)=Ω_{ARP} tan [α(2t/T_{π}−1)] Equation (3):

where
tε{0,T_{π}}, and T_{π} sets the total sweep duration,
Ω_{ARP} alters the sweep rate, and
α=arctan(δₘₐₓ/Ω_{ARP}), with δₘₐₓ being the maximum detuning.
The optical intensity was proportional to tan h [7.5(1−|2t/T_{π}−1)]. According to at least one embodiment, a tan/tan h pulse with duration T_{π}=10t_{π} (where t_{π} is the duration of a Raman π pulse) achieved ˜96% transfer efficiency over a broad range of detunings and was limited primarily by spontaneous emission.

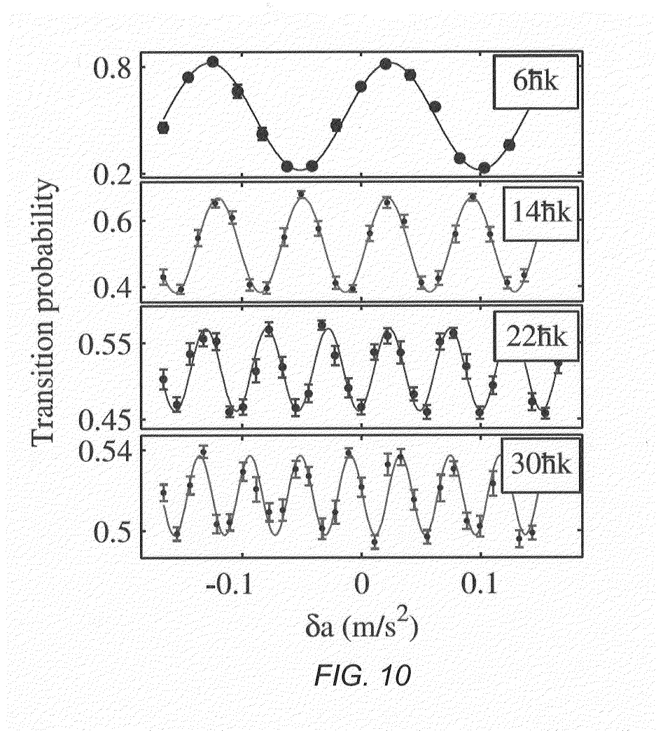

To verify the enhancement of phase shift per unit acceleration Δφ/a, interferograms were produced while varying the chirp rate of the Raman frequency difference. Using tan/tan h pulses, interference fringes with 6k, 14k, 22k, and 30k beamsplitter pulses were produced. A short dwell time of T=1 ms was used to reduce phase noise from environmental vibration. Other experimental parameters included T_{π}=3t_{π}, Ω_{eff}=Ω_{ARP}=2π×200 kHz, δₘₐₓ=2π×15 MHz, and τ=41 μs. The transition probability was measured following an interferometer while varying the chirp rate of the Raman frequency difference ω₁−ω₂. In response to the chirp rate variation, the interferograms exhibited periods that decreased with higher LMT order and matched expected values, as shown in FIG. 10 and Table 1 below. Similar agreement was verified for up to 14k beam splitters using Raman π pulses and tan/tan h pulses with Tπ=5tπ. As exemplified in FIG. 10, the resulting Doppler shift mimics a relative acceleration δa between the atoms and Raman beams. The points in FIG. 10 represent 10- or 15-shot averages, the error bars indicated standard error, and the lines are fitted sine waves. The 26k beam splitter pulse was not measured.

TABLE 1
measured and predicted phase shift per unit acceleration
values for various LMT orders

| LMT | Phase shift per unit acceleration Δφ/a (rad s²/m) | |
|---|---|---|
| order (hk) | Measured | Predicted |
| 2 | 14.8 (3) | 14.9 |
| 6 | 41.5 (3) | 41.7 |
| 10 | 67.1 (5) | 65.7 |
| 14 | 88.3 (3) | 86.9 |
| 18 | 105.3 (4) | 105.1 |
| 22 | 122.3 (7) | 120.5 |
| 26 | — | 133.1 |
| 30 | 149.1(7) | 146.9 |

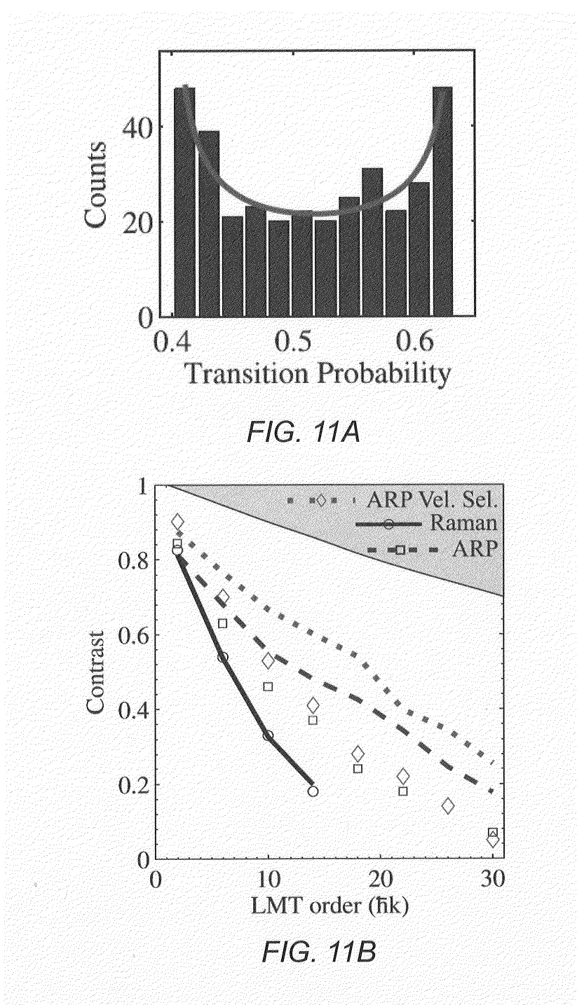

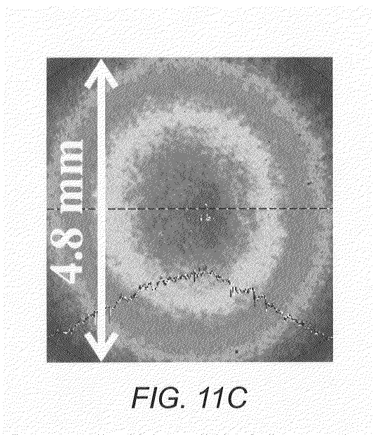

While the LMT interferometers clearly enhanced the phase shift per unit acceleration, the contrast C of the interferograms (i.e., the peak-to-peak variation in transition probability) was simultaneously degraded. In certain instances maintaining contrast may be important because it scales the measurement signal-to-noise ratio. To eliminate systematic underestimation of contrast due to vibration induced phase noise, C was assessed using histograms of transition probability measurements from each LMT interferometer. In accordance with various aspects, the arcsine probability density function characterizes the statistics of the transition probability in the limit of uniform random phase noise. In accordance with various aspects, this limit may be effectively produced through a combination of vibration-driven phase noise and deliberate variation of the interferometer phase, as seen in FIG. 11A, which illustrates a histogram of transition probabilities from an 18k interferometer with a fitted probability density function (see curve). The arcsine distribution was fit to the histograms, while keeping C a free parameter. The resulting contrast estimates are shown in FIG. 11B, where contrast is plotted as a function of LMT order and the lines are Monte Carlo predictions (discussed below), the points are contrast fits to histograms (see FIG. 11A), and fit uncertainties are smaller than symbol sizes. The contrast fits shown in FIG. 11B matched separate estimates of contrast based on the standard deviation of the transition probabilities: C_{σ}=2\sqrt{2}σ. At all LMT orders, tan/tan h interferometers achieve higher contrast than interferometers based on Raman π pulses. Assuming other noise processes were unchanged, the maximum inferred sensitivity (C×Δφ/a) occurred with 14k beamsplitters and was a factor of 2.6 larger than that of the 2k interferometer. Using velocity-selected samples with temperatures of ˜100 nK along the Raman beam axis, a nominal increase in contrast was observed. Since this improvement was largely driven by the 2k interferometer, it is hypothesized that inhomogeneity in the temperature-dependent Doppler detuning was not the dominant loss mechanism.

The loss of contrast observed with increasing LMT order may be driven by one or more factors: single-photon excitations, detuning offsets due to the oppositely directed recoil velocities of each interferometer arm, detuning inhomogeneity due to temperature-dependent Doppler shifts, and Rabi rate and spatial phase inhomogeneity due to a combination of optical wave front distortion and thermal motion of the atoms. Monte Carlo interferometer simulations were used to jointly study these effects. The inhomogeneity effects mentioned above were accounted for by using normally distributed and centered initial atom positions and velocities on the Raman beam axis. The Raman process was modeled as an effective two-level system with uniform Raman wave fronts. To reduce computation times, probability amplitudes corresponding to population loss were not computed, since they do not contribute significantly to contrast. A CCD image of the spatial intensity profile of one Raman laser beam, shown in FIG. 11C, was used to approximate the true variation in Ω_{eff} with position. Non-ideal spatial modes are an important source of contrast loss in ARP-based LMT interferometers, because they introduce variations in the dynamic phase γ across the sample. To account for spontaneous emission, the simulated contrast results were scaled by (1−R_{sd})^{4Nt}^{_{aug}}⁺², where t_{aug} was the augmentation pulse duration in units of tπ, and R_{sd}=0.004 was the population fraction lost to spontaneous decay per a pulse.

Using known experimental parameters and adjustments to the atom sample size (order 10%), the simulation produced contrast values that agreed with measurements based on Raman π augmentations, as shown in FIG. 11B. With the same experimental parameters, simulations based on tan/tan h augmentation pulses predicted higher levels of contrast at all LMT orders. These predictions were borne out qualitatively in experiments, though the measured contrast values were lower. The discrepancy may have resulted from dephasing due to aberrations in the true Raman beam wave front, as well as an optimistic model of the Raman beam intensity profile, which accounted for just one of the two Raman beams.

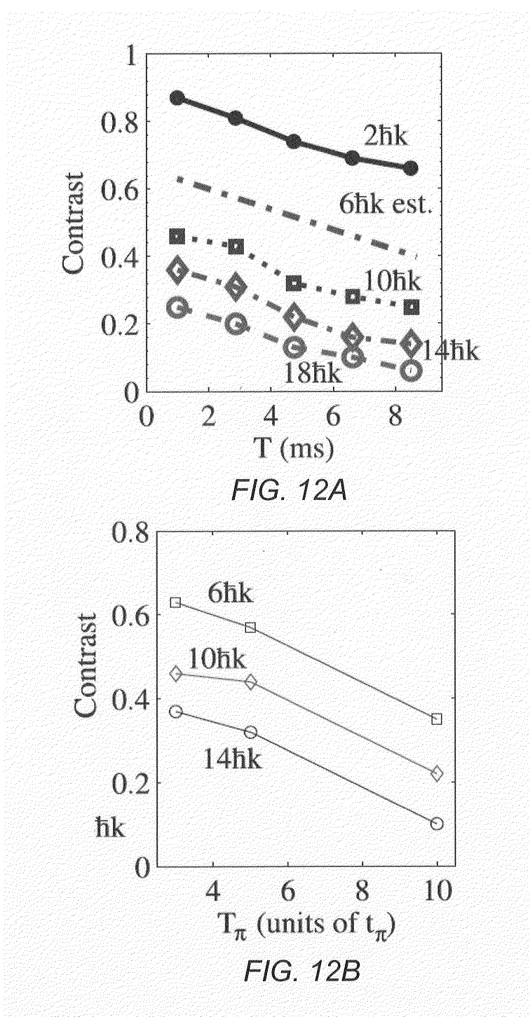

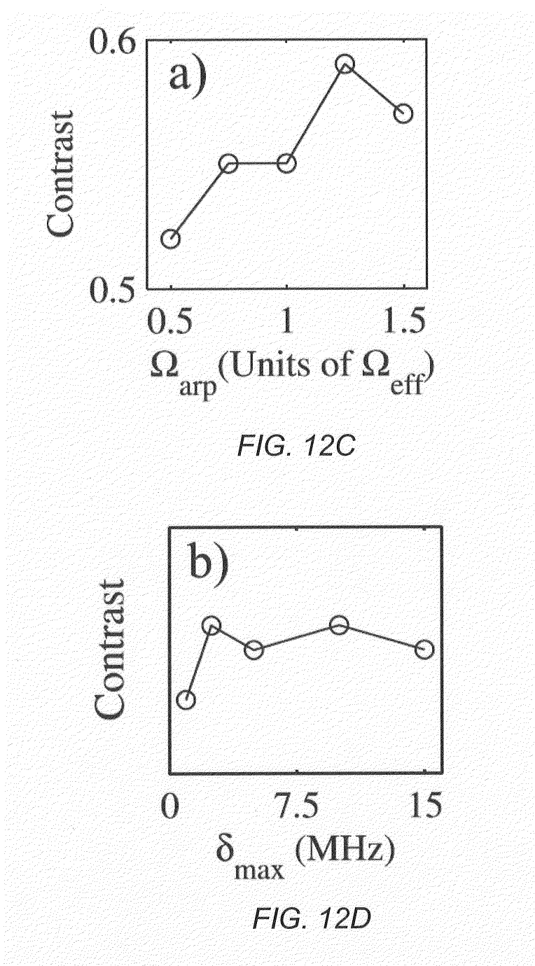

As a function of dwell time T, the measured contrast (see FIG. 12A) decreased at a rate of roughly 0.03/ms for all LMT orders, with the estimates for the 6k interferometer in FIG. 12B being based on a contrast measurement at T=1 ms. Without being bound by theory, it is hypothesized that this trend may be due to the transverse motion of atoms in laser beams with spatially nonuniform intensity and wave front aberrations, both of which increasingly dephase the atoms over longer T. For instance, the transverse ˜2-cm/s RMS velocity of a 9-μK cloud of ¹³³Cs atoms, with an initial 1/e² diameter of 2 mm, causes a 40% expansion of the sample during an interferometer with T=8.5 ms. This expansion may be reduced by as much as a factor of three by implementing improved laser cooling and is accomplished without evaporative cooling or velocity selection.

Contrast sensitivity to ARP dynamic phase γ was assessed by varying the ARP pulse duration Tπ, because the uncertainty in γ due to intensity inhomogeneity is proportional to Tπ. The contrast as a function of increasing Tπ (ARP duration), as illustrated FIG. 12B, decreased at all LMT orders, even though the velocity acceptance of the ARP pulses improved with duration. Both spontaneous emission and dephasing of γ contributed to this trend. However. Monte Carlo simulations with ideal Gaussian laser beams. ARP pulses with Tπ=10t_{π}, and even values of N predicted nearly spontaneous emission-limited contrast for the dwell times, atom cloud size, and Raman pulse parameters considered in these experiments. For the experimental pulse parameters, the dynamic phases from Tπ=3t_{π} and 10t_{π} ARP pulses vary by 3 and 10 mrad, respectively, in response to 0.1% deviations in optical intensity (i.e., Ω_{eff}). Given the cm/s-atom velocities and 40-μs beam splitter pulse spacings used, an atom moving in an ideal Gaussian beam experiences pulse-to-pulse intensity variations below 0.1%. Rephasing may therefore be highly efficient in this scenario. Therefore, observation of experimental contrast loss indicates that rephasing—though certainly occurring—may be limited by beam quality. Exclusive use of optical elements with flatness ≦λ/10 may further enhance LMT interferometer contrast.

Estimates of dynamic phase sensitivity to optical intensity (see above) indicate that uncorrelated 100-ppm pulse-to-pulse jitter in overall optical power produces an LMT interferometer phase uncertainty of ˜\sqrt{N} mrad. This level of power stability may only be required during the ˜100-μs beam splitter or mirror sequences, and not over longer times. Experimentally observed phase noise in 6k interferometers based on tan/tan h and Raman in augmentation pulses was similar and largely driven by vibrations, indicating reasonably well controlled dynamic phase. For example, contrast sensitivity to ARP sweep-defining parameters Ωₐᵣₚ and δₘₐₓ were also assessed. FIGS. 12C and 12D show small variation in contrast for a 6k interferometer for a broad range of Ωₐᵣₚ and δₘₐₓ values. Furthermore, the standard deviations of the interferogram phase offsets were <70 mrad. According to certain aspects, if Ω_{eff} were constant, consecutive pairs of closely spaced augmentation pulses would cancel γ in the adiabatic limit, because the imprinted phases would carry opposite signs. Improvements to the spatial mode quality of the Raman beams may enable application of spontaneous emission-limited tan/tan h pulses with Tπ=10t_{π}, as well as cancellation of dynamic phases between consecutive pulses. In accordance with various aspects, further suppression of spontaneous emission and simultaneous cancellation of the AC Stark shift may be possible with far-detuned, high-power lasers.

To illustrate the utility of LMT with frequency-swept ARP, recall that the requirements ARP atom optics place on beam quality and optical power control are balanced by the benefits of a higher data rate and atom number, as well as circumvention of evaporative cooling and 2D MOTs. Furthermore, an atom shot-noise-limited accelerometer operating with 10⁶ atoms, T=5 ms, and efficient 22k ARP beam splitters would resolve ˜30×10⁻⁹-g variations in acceleration per shot. At data rates approaching 100 Hz, such a device would provide 10⁻⁹-g/\sqrt{Hz} sensitivity while maintaining sufficient compactness and bandwidth for precision inertial sensing. By comparison, a 2k interferometer would need a dwell time of T=25 ms and a corresponding factor-of-5 reduction in data rate and bandwidth to achieve this level of sensitivity. Combining LMT with higher atom number and data-rates may also prove useful in a variety of applications. For instance, increasing the dwell time in the previous example to T=330 ms may increase sensitivities. Further, the beamsplitter momentum transfer may be increased beyond 30k by switching to diffraction of a single interferometer arm with resonant pulses. This approach may be advantageously efficient when the separation between wavepacket resonances (induced by photon recoils) exceeds the temperature-dependent detuning inhomogeneity. In certain instances, for a 1-μK sample of ¹³³Cs atoms. 14k beamsplitters may provide the necessary frequency separation.

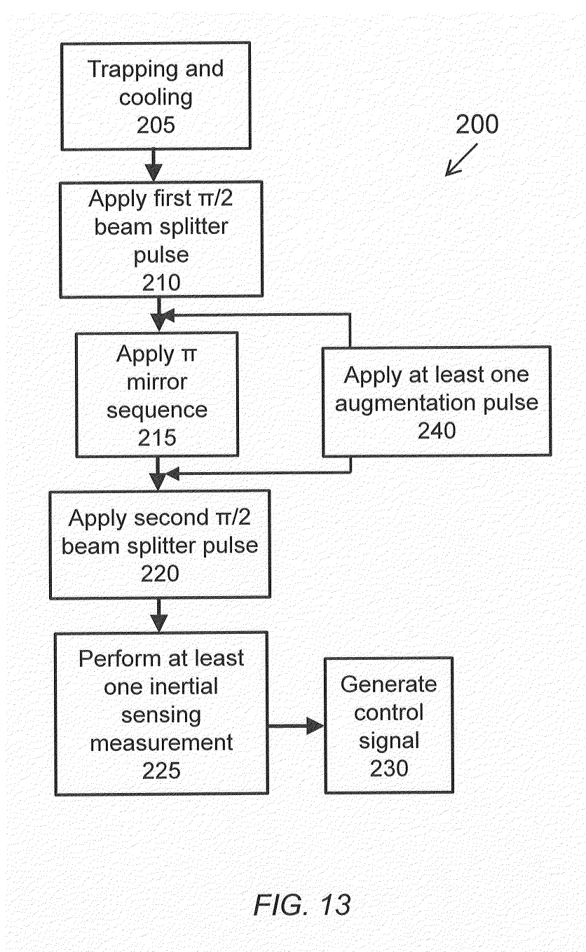

FIG. 13 is a flow diagram of at least one example of a method 200 according to one or more aspects of the systems and devices discussed above. At step 205, a cloud of atoms that includes a plurality of atom wave packets may be trapped and cooled. For instance, the cloud of atoms may be trapped and cooled to a predetermined temperature suitable for inertial sensing, which in certain instances may be at least 9 micro-Kelvin. At step 210, a first π/2 beam splitter pulse sequence may be applied to the cloud of atoms. As discussed above, the first π/2 beam splitter pulse sequence may drive a first Raman transition and divide the atom wave packets. At step 215, a π mirror sequence may be applied to the cloud of atoms. For instance, the π mirror sequence may drive a second Raman transition and recombine the atom wave packets. At step 220, a second π/2 beam splitter pulse sequence may be applied to the cloud of atoms. The second π/2 beam splitter pulse sequence may drive a third Raman transition and overlap the atom wave packets to produce interference among the plurality of wave packets. The method 200 may also include applying at least one augmentation pulse (240). In accordance with various embodiments, the at least one augmentation pulse may be applied after the first π/2 beam splitter pulse sequence and/or after the π mirror sequence. At step 225 at least one inertial sensing measurement may be performed, and at step 230 a control signal may be generated based on the at least one measurement. According to various aspects, the control signal may be used to control one or more operations in a navigation device or system, for example, in operations related to determining location. For instance, measurements related to acceleration or rotation sensing may be used to generate a control signal that is then used by a navigation device. According to some embodiments, the method may be used for applications involving dynamic signals. For instance, the method may be used for applications involving sensors configured to measure dynamic signals, such as accelerations and rotations of a moving platform.

Method 200 of FIG. 13 depicts one particular sequence of acts in a particular embodiment. The acts included in this method may be controlled by one or more computer systems, such as a controller, that is specially configured to perform these operations. Some acts are optional and, as such, may be omitted in accord with one or more embodiments. Additionally, the order of acts can be altered, or other acts can be added, without departing from the scope of the embodiments described herein.

The aspects disclosed herein in accordance with the present invention, are not limited in their application to the details of construction and the arrangement of components set forth in the following description or illustrated in the accompanying drawings. These aspects are capable of assuming other embodiments and of being practiced or of being carried out in various ways. Examples of specific implementations are provided herein for illustrative purposes only and are not intended to be limiting. In particular, acts, components, elements, and features discussed in connection with any one or more embodiments are not intended to be excluded from a similar role in any other embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated reference is supplementary to that of this document; for irreconcilable inconsistencies, the term usage in this document controls. Moreover, titles or subtitles may be used in the specification for the convenience of a reader, which shall have no influence on the scope of the present invention.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A method of inertial sensing using large momentum transfer atom interferometry, the method comprising:
trapping and cooling a cloud of atoms that includes a plurality of atom wave packets;
applying a first π/2 beam splitter pulse sequence to the cloud of atoms to drive a first Raman transition and divide the atom wave packets;
applying a π mirror sequence to the cloud of atoms to drive a second Raman transition and recombine the atom wave packets;
applying a second π/2 beam splitter pulse sequence to the cloud of atoms to drive a third Raman transition and overlap the atom wave packets to produce interference among the plurality of atom wave packets, a combination of the first π/2 beam splitter pulse sequence, the π mirror sequence, and the second π/2 beam splitter pulse sequence producing a 2k momentum splitting between interfering atom wave packets of the plurality of atom wave packets;
applying at least one augmentation pulse to the cloud of atoms to increase the momentum splitting to a value greater than 2k, the at least one augmentation pulse being at least one of a Raman pulse, a composite pulse, and an adiabatic rapid passage (ARP) pulse;
performing at least one inertial sensing measurement on the cloud of atoms during an interrogation time; and
generating a control signal based on the at least one inertial sensing measurement.

2. The method of claim 1, wherein the first and second π/2 beam splitter pulse sequences, the π mirror sequence, and the at least one augmentation pulse are applied in a Mach-Zehnder atom interferometer.

3. The method of claim 2, wherein applying the at least one augmentation pulse increases the momentum splitting to a value of at least 4k.

4. The method of claim 3, wherein the momentum splitting is increased to a value of at least 30k.

5. The method of claim 1, wherein the at least one augmentation pulse is an ARP pulse.

6. The method of claim 5 wherein the ARP pulse is a tan/tan h pulse.

7. The method of claim 6, wherein the ARP pulse has a duration of 10t_{π}.

8. The method of claim 1, wherein performing the at least one inertial sensing measurement is determined at a specified periodic rate of at least 100 Hz.

9. The method of claim 8, wherein the π mirror sequence is applied following the first π/2 beam splitter pulse sequence after a dwell time of at least 5 ms.

10. The method of claim 1, wherein the at least one augmentation pulse is chirped at a predetermined rate.

11. The method of claim 10, wherein the predetermined rate is ±23 kHz/ms.

12. The method of claim 1, further comprising recapturing a substantial portion of the atom wave packets of the cloud of atoms following performance of the at least one inertial sensing measurement.

13. The method of claim 1, wherein the at least one augmentation pulse includes a plurality of augmentation pulses temporally separated from one another by a predetermined time τ.

14. The method of claim 1, further comprising modulating a phase of at least one of the first and second π/2 beam splitter pulse sequences.

15. An atom interferometer, comprising:
an atom cloud including a plurality of atom wave packets;
a trap configured to trap and cool the plurality of atom wave packets to a predetermined temperature and launch the plurality of atom wave packets into an interferometry region;
at least one laser light source disposed adjacent to the interferometry region and configured to generate and direct a sequence of light pulses into the interferometry region; and
a controller coupled to the at least one laser light source and configured to obtain at least one inertial sensing measurement from the atom cloud and control the at least one laser light source to:
apply a first π/2 beam splitter pulse to drive a first Raman transition and divide the atom wave packets;
apply a π mirror sequence to drive a second Raman transition and recombine the atom wave packets;
apply a second π/2 beam splitter pulse to drive a third Raman transition and overlap the atom wave packets to produce interference among the plurality of atom wave packets, a combination of the first π/2 beam splitter, the π mirror sequence, and the second π/2 beam splitter pulse producing a 2k momentum splitting between interfering atom wave packets of the plurality of atom wave packets; and
apply at least one augmentation pulse, the at least one augmentation pulse being at least one of a Raman pulse, a composite pulse, and an adiabatic rapid passage (ARP) pulse and configured to increase the momentum splitting to a value greater than 2k.

16. The atom interferometer of claim 15, wherein the trap is a first trap and the atom interferometer further comprises a second trap, the second trap configured to capture a substantial portion of the plurality of atom wave packets launched into the interferometry region by the first trap.

17. The atom interferometer of claim 16, wherein the at least one augmentation pulse is configured to increase the momentum splitting to a value of at least 30k.

18. The atom interferometer of claim 15, wherein the at least one laser light source comprises counter-propagating beams of light directed at the plurality of atom wave packets.

19. The atom interferometer of claim 15, further comprising an electro-optic modulator coupled to the at least one laser light source and configured to modulate a phase of at least one of the first and second π/2 beam splitter pulse sequences.

20. The atom interferometer of claim 15, wherein the π mirror sequence is applied after a first dwell time after the first π/2 beam splitter pulse, and the second π/2 beam splitter pulse is applied after a second dwell time after the π mirror sequence, the first and the second dwell time having a duration of at least 5 msec.
